(19) United States
(12) Patent Application Publication
(10) Pub. No.: US 2026/0350429 A1
(43) Pub. Date: Nov. 5, 2026

(54) LIGHTWEIGHT DOMAIN SPECIFIC LANGUAGE RULES ENGINE

(71) Applicant: Bytedance Technology Ltd., Grand Cayman (KY)

(72) Inventor: Jun ZENG, Culver City, CA (US)

(21) Appl. No.: 19/074,791

(22) Filed: Mar. 10, 2025

(51) Int. Cl. G06N 5/025

(52) U.S. Cl. CPC G06N 5/025

(57) ABSTRACT

The present disclosure involves methods, apparatus, and systems for a rules engine. This can include identifying a request to be analyzed by a rules engine; identifying a plurality of facts associated with the request; loading the plurality of facts into a working memory; performing an inference process on a Rete network using the plurality of facts to generate an output of the rules engine; and generating an agenda that specifies the output of the rules engine.

### TECHNICAL FIELD

The present disclosure generally relates to using domain specific language (DSL) objects in a rules engine.

### BACKGROUND

Rules engines are software systems that execute predefined rules to automate decision-making. They operate by taking input data, or facts, and comparing them against a set of rules, and then producing decisions or performing actions based on which rules are triggered. This can enable flexible and dynamic automation of complex processes. Rules engines can be particularly useful in scenarios requiring frequent changes to the comparative logic, such as fraud detection, risk assessment, and policy management.

### SUMMARY

The present disclosure relates to a method, system, and computer-readable storage media for a rules engine. This can include identifying a request to be analyzed by a rules engine; identifying a plurality of facts associated with the request; loading the plurality of facts into a working memory; performing an inference process on a Rete network using the plurality of facts to generate an output of the rules engine; and generating an agenda that specifies the output of the rules engine.

Implementations can optionally include one or more of the following features.

In some instances, identifying the plurality of facts comprises querying an external database and receiving a return.

In some instances, the Rete network is stored in a shared memory as a concurrency-safe, read-only file.

In some instances, the method, system, and media can further include identifying a plurality of rule definitions; generating an abstract syntax tree (AST) for each rule definition; aggregating each AST to generate a concurrency safe Rete network; and storing the Rete network in a read-only format in a shared memory.

In some instances, the agenda comprises a scope, wherein the scope defines a list of permissions associated with the request.

In some instances, the agenda comprises an action, wherein the action defines a status to be updated in response to the request.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system for a lightweight domain specific language (DSL)-based rules engine.

FIG. 2 illustrates an example Rete network.

FIG. 3 illustrates an example Rete network during an inference operation.

FIG. 4 is a flowchart showing an example process for generating a Rete network.

FIG. 5 is a flowchart showing an example process for executing a lightweight DSL-based rules engine.

FIG. 6 illustrates a schematic diagram of an example computing system.

Like reference numbers and designations in the various drawings indicate like elements.

### DETAILED DESCRIPTION

This specification relates to methods, apparatuses, and systems for lightweight rules engine that uses domain specific language (DSL) objects. A powerful rules engine with strong performance and flexible extensibility is disclosed in this solution. The rules engine can do evaluation on a large scale of both input parameters and preconfigured compliance policies/rules. The disclosed solution does not merely handle legal-sense rules inference (e.g. only adults can stream LIVE), but also decouples the research and development rules across regions or business lines in a large-scale enterprise (e.g., the calculation criteria of underage and minors can be based on different age thresholds). Currently, most of these compliance rules are distributed in different services and teams under their own maintenance. This can make it difficult when managing, converging, and auditing. Additionally, this rules engine can automatically trigger follow up actions when specific compliance conditions are met to ensure end-to-end compliance policy enforcement in both access control and decision execution.

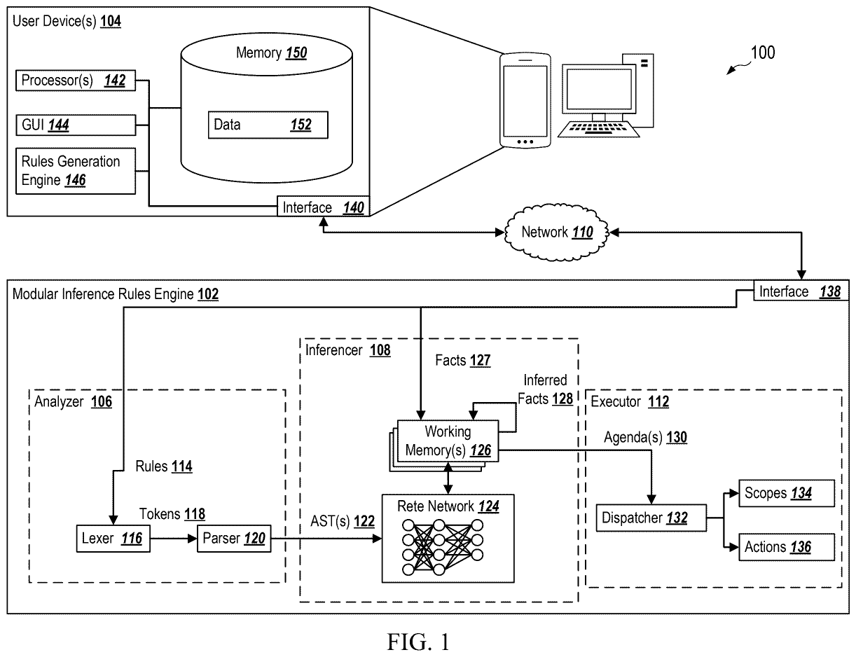

FIG. 1 illustrates a block diagram of an example system 100 for a lightweight DSL-based rules engine. The system 100 includes a modular inference rules engine 102, and one or more user devices 104, which can communicate using a network 110.

Network 110 facilitates wireless or wireline communications between the components of the system 100 (e.g., between the modular inference rules engine 102, and the user devices 104), as well as with any other local or remote computers, such as additional mobile devices, clients, servers, or other devices communicably coupled to network 110, including those not illustrated in FIG. 1. In the illustrated environment, the network 110 is depicted as a single network, but can comprise more than one network without departing from the scope of this disclosure, so long as at least a portion of the network 110 can facilitate communications between senders and recipients. In some instances, one or more of the illustrated components (e.g., a Rete network 124 and the working memory 126) can be included within or deployed to network 110 or a portion thereof as one or more cloud-based services or operations. The network 110 can be all or a portion of an enterprise or secured network, while in another instance, at least a portion of the network 100 can represent a connection to the Internet. In some instances, a portion of the network 110 can be a virtual private network (VPN). Further, all or a portion of the network 110 can comprise either a wireline or wireless link. Example wireless links can include 802.11a/b/g/n/ac, 802.20, WiMax, LTE, and/or any other appropriate wireless link. In other words, the network 110 encompasses any internal or external network, networks, sub-network, or combination thereof operable to facilitate communications between various computing components inside and outside the illustrated system 100. The network 110 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

The modular inference rules engine 102 can be a server based, cloud-based, or locally executing system that generally receives sets of rules and facts from one or more user devices 104 and runs inferences to determine scopes 134 or actions to be taken 136. The modular inference rules engine 102 includes an analyzer 106, an inference 108, and an executor 112 as well as an interface 128.

Interface 138 is used by the modular inference rules engine 102 to communicate with other systems in a distributed environment-including within the system 100 connected to the network 110 (e.g., user devices 104, and other systems communicably coupled to the illustrated modular inference rules engine 102 and/or network 110). Generally, the interface 138 includes logic encoded in software and/or hardware in a suitable combination and operable to communicate with the network 110 and other components. More specifically, the interface 138 can include software supporting one or more communication protocols associated with communications such that the network 110 and/or interface's 138 hardware is operable to communicate physical signals within and outside of the illustrated system 100. Still further, the interface 138 can allow the modular inference rules engine 102 to communicate with the user devices 104, and/or other portions illustrated within the system 100 to perform the operations described herein.

The analyzer 106 receives rules 114 from a user device 104 (e.g., using rules generation engine 146 as described in more detail below) and uses the rules 114 to produce abstract syntax trees (ASTs) 122 for the Rete network 124. The analyzer 106 includes a lexer 116 and a parser 120. In general, both the lexer 116 and the parser 120 are based on pre-defined context-free grammar for DSL recognition and, combined generate an AST 122 for each rule. The lexer 116 breaks the input character stream (from the rules generation engine 146) into a series of tokens 118 for consumption by the parser. The parser 120 uses the token to generate an AST 122 for each new rule. In some implementations, the analyzer 106 can be a computational language tool (such as, the ANTLR (Another Tool for Language Recognition) or other) tool. Generally, the analyzer 106 parses input grammars and rules 114 into ASTs 122.

ASTs 122 are tree-like representations of the structure of source code (or rules). An AST 122 breaks down the code into its essential components and shows how they relate to each other. An AST can be focused on the meaning of the code, omitting unnecessary details like parentheses or semicolons. Each node in the AST can represent a construct in the code, such as an expression, statement, or declaration. ASTs can provide the Rete network with a structured way to analyze and manipulate rules during the inference process.

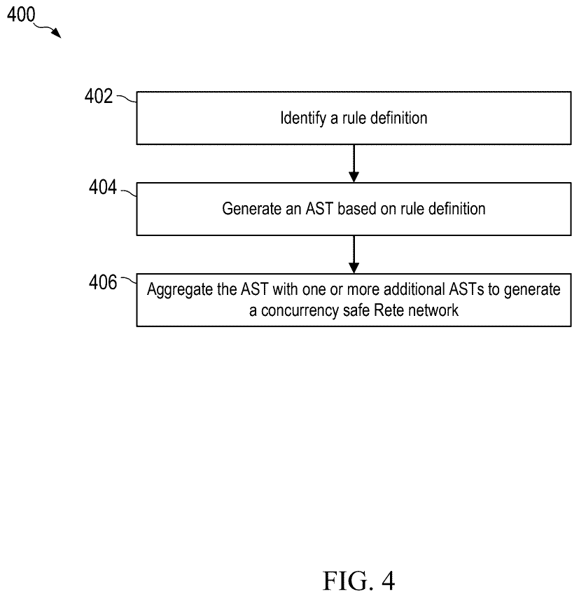

The inferencer 108 receives ASTs 122 from the analyzer 106 and generates a Rete network 124 from them. The inferencer 108 also ingests facts 127, in order to run an inference on the Rete network 124 and produce an agenda 130. The inferencer 108 assembles the ASTs 122 into the Rete network by converting the SQL-like statements of the ASTs 122 into logical inference process networks. For example, parenthesis and AND/OR logics need to be parsed correctly into the Rete network 124. This process is described in further detail below with respect to FIG. 4.

The Rete network 124 is a rule-based network implemented using a pattern matching Rete algorithm, which can efficiently apply rules or patterns to many objects (or facts) in a knowledge base. The Rete network 124 is used for efficient pattern matching, particularly in rule-based systems and expert systems. The Rete network 124 can be designed to solve the many-to-many matching problem, where numerous rules need to be compared against a large set of facts. The Rete algorithm achieves efficiency by storing partial matches representing a network of nodes in a per-request working memory. This avoids redundant computations when new facts are added, or existing facts are modified. This allows the system to quickly identify which rules are satisfied by the current set of facts, making it ideal for applications that require real-time or near real-time rule evaluation. The Rete network 124 can be generated during the server bootstrap, or startup of the modular inference rules engine 102. That is, the Rete network 124 need not be built during runtime. Additionally, the Rete network 124 can be stored in a read-only format, which makes it concurrency-safe. That is, multiple simultaneous requests or inferences can be conducted on a single Rete network 124 because each request or inference is allocated a working memory 126 to execute the process.

The working memory 126 is used to store the inference status and set of facts for each inference process. In general all inputs, intermediate states, and results are stored in the working memory 126. The process of inference can include identifying or inferring new facts as inferred facts 128. In some implementations, inference is executed iteratively, with each iteration proceeding to a new depth in the Rete network 124 until all possible rules have been either triggered or not triggered, and all facts 127 and inferred facts 128 have been analyzed. The final output of the inference is an agenda 130, which includes a set of rules that the inference matches, associated scopes to grant based on those rules, actions to be taken if any, and new facts that can be parsed or identified.

The executor 112 ingests the agenda 130, and outputs the associated scopes 134 and actions 136 that are to be taken in accordance with the original request. A dispatcher 132 can parse the agenda 130 to extract scopes 134. Scopes 134 can be a set of permissions or access rights to be either granted or not granted based on the initial request and inference process. Actions 136 can be processes that need to be executed in response to the request. For example, actions 136 can include a call and parameters for upstream execution, and can be updating a status, changing data, reading new information, or sending an alert, among other things. In some implementations, the dispatcher stores any ingested agendas 130 in a memory for future auditing, training or model development, or compliance requirements.

User devices 104 can be computing devices or computers used by one or more users and developers of the software and hardware within system 100. For example, the user devices 104 can interact with the modular inference rules engine 102 to request access or perform actions within the network 110. As used in the present disclosure, the term “computer” or “computing devices” is intended to encompass any suitable processing device. For example, the user devices 104 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems. The user devices 104, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The user devices 104 can include one or more specific applications executing on the user devices 104, or the user devices 104 can include one or more Web browsers or web applications that can interact with particular applications executing remotely from the user devices 104. User devices 104 can include a memory 150, which can store device data 152. The user devices 104 can include an interface 140 which enables communication with other components of system 100, and can be similar to interface 138.

Memory 150 can represent a single memory or multiple memories. The memory 150 can include any memory or database module and can take the form of volatile or non-volatile memory including, without limitation, magnetic media, optical media, random access memory (RAM), read-only memory (ROM), removable media, or any other suitable local or remote memory component. The memory 150 can store various objects or data, including digital asset data, public keys, user and/or account information, administrative settings, password information, caches, applications, backup data, repositories storing business and/or dynamic information, and any other appropriate information associated with the user devices 104, including any parameters, variables, algorithms, instructions, rules, constraints, or references thereto. Additionally, the memory 150 can store any other appropriate data, user profiles, algorithms, or processes, firmware logs and policies, firewall policies, a security or access log, print or other reporting files, as well as others. While illustrated within the system 100, memory 150 or any portion thereof, including some or all of the particular illustrated components, can be located remote from the system 100 in some instances, including as a cloud application or repository or as a separate cloud application or repository when the system 100 itself is a cloud-based system.

Each of the one or more processors 142 can be a central processing unit (CPU), an application specific integrated circuit (ASIC), a field-programmable gate array (FPGA), or another suitable component. Generally, the processor 142 executes instructions and manipulates data to perform the operations of the user device 104. Specifically, the processor 142 executes the algorithms and operations described in the illustrated figures, as well as the various software modules and functionality, including the functionality for sending communications to and receiving transmissions from the modular interface rules engine 102, as well as to other devices and systems. Each processor 142 can have a single or multiple cores, with each core available to host and execute an individual processing thread. Further, the number of, types of, and particular processors 142 used to execute the operations described herein can be dynamically determined based on a number of requests, interactions, and operations associated with the user device 104.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of fourth-generation programming language (4GL), as well as others.

GUI 144 of the user device 104 interfaces with at least a portion of the system 100 for any suitable purpose, including generating a visual representation of any particular application or results and/or the content associated with any components of the modular inference rules engine 102. In particular, the GUI 144 can be used to present results of a query or search, or allow a developer to input queries or prompts to the modular inference rules engine 102, as well as to otherwise interact and present information associated with one or more applications. GUI 144 can also be used to view and interact with various web pages, applications, and web services located local or external to the modular inference rules engine 102. Generally, the GUI 144 provides the user with an efficient and user-friendly presentation of data provided by or communicated within the system. The GUI 144 can include a plurality of customizable frames or views having interactive fields, pull-down lists, and buttons operated by the user. In general, the GUI 144 is often configurable, supports a combination of tables and graphs (e.g., bar, line, pie, and/or status dials), and is able to build real time portals, application windows, and presentations. Therefore, the GUI 144 contemplates any suitable GUI, such as a combination of a generic web browser, a web-enabled application, intelligent engine, and command line interface (CLI) that processes information in the platform and efficiently presents the results to the user visually.

The rules generation engine 146 can be an application that uses GUI 144 to enable users of user devices 104 to generate or submit new rules, or sets of rules to the modular inference rules engine 102. In some implementations, rules generation engine 146 enables users to readily generate branching rule structures using, for example, drag and drop nodes and edges, to then create new rulesets for the modular inference rules engine 102. In some implementations, the rules generation engine 146 captures required facts and conditions, as well as relationships between those conditions, to enable rules to be converted into an AST.

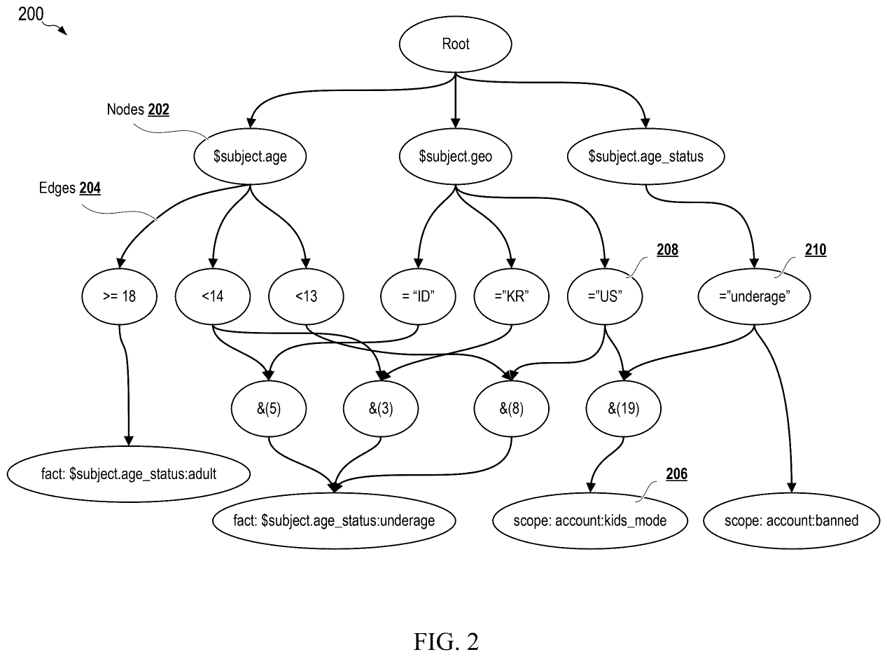

FIG. 2 illustrates an example Rete network 200. The example Rete network 200 includes nodes 202, which each represent a status or fact. Connections between the nodes are formed by edges 204, which define the relationships between facts and identify pathways required to trigger certain statuses. For example, in the illustrated network 200, a user can be granted a scope “account: kids_mode” 206 only if they satisfy the facts of being geographically located in “US” 208 and have an age status of “underage” 210.

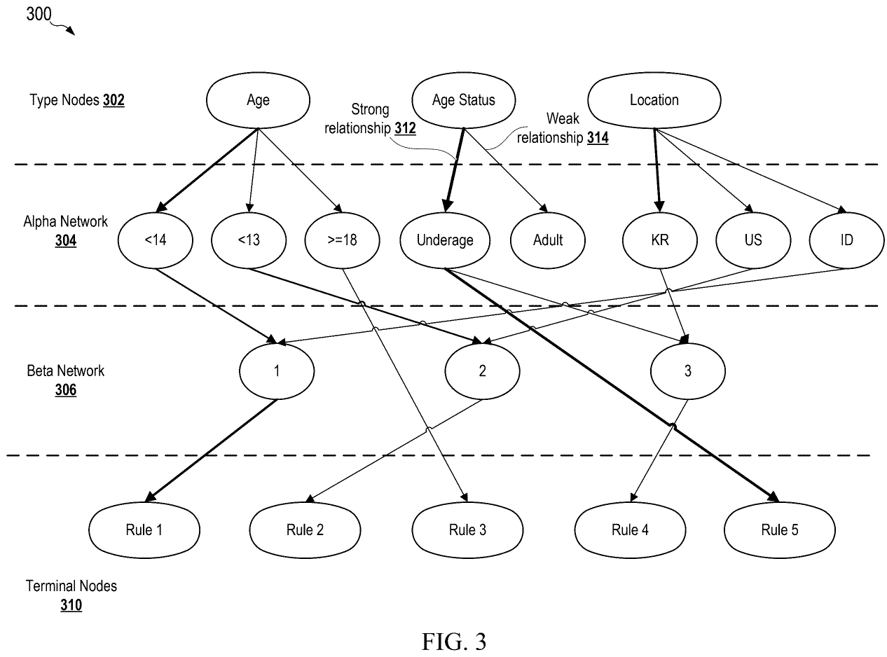

FIG. 3 illustrates an example Rete network during an inference operation. In the illustrated network 300, the weights of each arrow indicate how strongly the current set of facts is triggering a given rule or relationship. For example, there is a strong relationship 312 between the age status and “underage,” and a weak relationship 314 between the age status and “adult”. The Rete network 300 will include four tiers, type nodes 302, an alpha network 304, a beta network 306, and terminal nodes 310.

The alpha network 304 is a discrimination network that can select individual working memory elements (WMEs) based on conditional tests that match WME attributes against constant values. Nodes in the discrimination network may also perform tests that compare two or more attributes of the same WME. If a WME is successfully matched against the conditions represented by one node, it is passed to the next node.

The beta network 306 performs joins between related nodes of the alpha network 304. The results of the beta network 306 are passed to the terminal nodes 310 which identify which rules are triggered and to be assigned to the agenda.

In addition to the triggered rules, additional extensions are possible. For example, each rule can be assigned a priority, such that the execution of those rules will occur in a known or predetermined order. Additionally, a default rule can be added to trigger if no other rule is triggered.

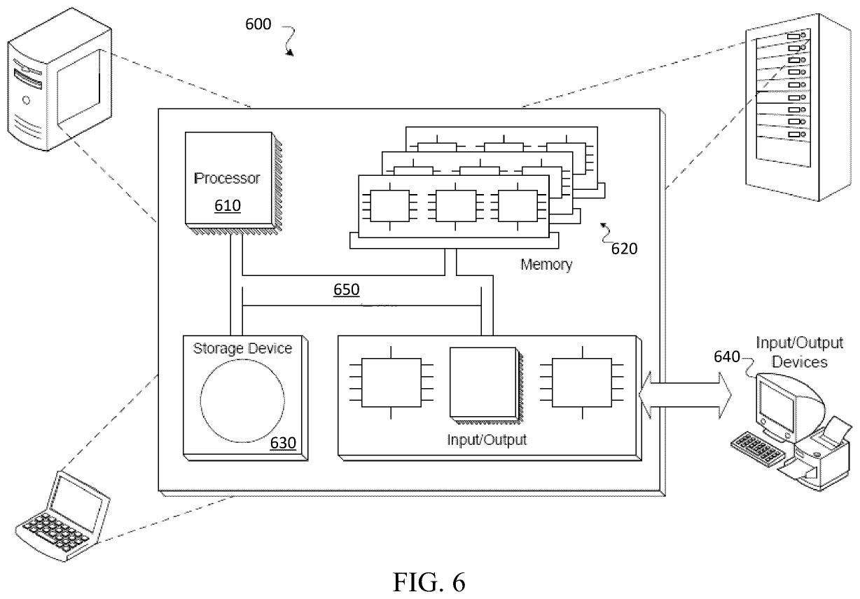

FIG. 4 is a flowchart illustrating an example process 400 for generating a Rete network. The example process 400 can be performed by a system for example, system 100 as described above with respect to FIG. 1. The operations shown in process 400 may not be exhaustive and other operations can be performed as well before, after, or in between any of the illustrated operations. Further, some of the operations may be performed simultaneously, or in a different order than shown in FIG. 4. In some implementations, some of the operations may be performed by a computer, or multiple computers. The one or more computers the process 400 will be described as being performed by a system of, located in one or more locations, and programmed appropriately in accordance with this specification. For example, one or more of a computation system 600 of FIG. 6, appropriately programmed, can perform the process 400.

At 402, a rule definition is identified. The rule definition can include one or more necessary facts to be compared against one or more conditions. These rule definitions can be generated, for example, by a rule generation engine 146 as described above with respect to FIG. 1.

At 404, an abstract syntax tree (AST) is generated based on the rule definition. The AST can be generated by converting the rule definition into a set of tokens, and then the tokens are parsed into the AST.

At 406, the AST for each rule definition is aggregated into a Rete network. By storing the Rete network in a read-only format, the network is made concurrency-safe, which enables efficient execution of multiple simultaneous inferences. The Rete network is generated by traversing each condition in each AST to identify sub-condition (406A). Sub-conditions can each be handled recursively. Each condition is then parsed into an operator and comparison combination (406B). For example, for a condition of “age=17 AND geo=‘TH’”, one operator-comparison combination can be “AND age=17” and a second operator-comparison combination can be “AND geo=TH.” With the operator-comparison combination, the nodes of the Rete network can be defined (406C). For example, for AND logic the beta nodes will fan out from the alpha nodes. OR logic will instead decouple the comparison. Finally paths or edges can be defined from each alpha node, through the beta nodes and to the terminal nodes to form the Rete network (406D).

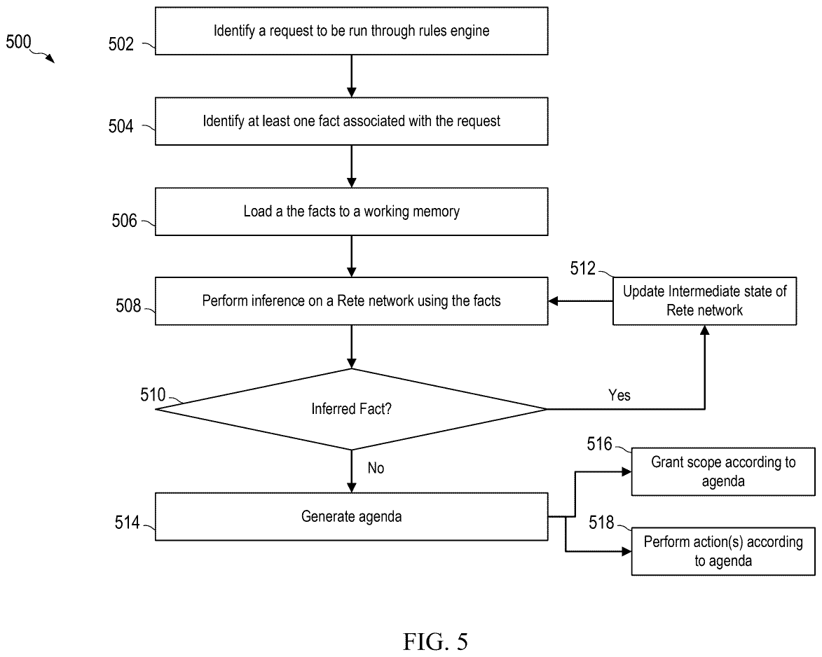

FIG. 5 is a flowchart showing an example process 500 for executing a lightweight DSL-based rules engine. The example process 500 can be performed by a system for example, modular inference rules engine 102 as described above with respect to FIG. 1. The operations shown in process 500 may not be exhaustive and other operations can be performed as well before, after, or in between any of the illustrated operations. Further, some of the operations may be performed simultaneously, or in a different order than shown in FIG. 5. In some implementations, some of the operations may be performed by a computer, or multiple computers. The one or more computers the process 500 will be described as being performed by a system of, located in one or more locations, and programmed appropriately in accordance with this specification. For example, one or more of a computation system 600 of FIG. 6, appropriately programmed, can perform the process 500.

At 502, a request is identified that is to be run through a rules engine. The request can include a number of facts, and can be, for example, a request for access to a certain set of data or functionality in a computer system. In some implementations, the request can include authentication tokens, or credentials that enable verification of the request's origin. In some implementations, the request is encrypted, and can be decrypted before being processed.

At 504, at least one fact associated with the request is identified. In some implementations, many facts are identified which can be interrelated. For example, a fact may include a user's birth date, and a second fact can include the current date. Finally, the rules engine can infer the user's age from the two previous facts and add that as an inferred fact.

At 506, the facts are loaded into a working memory, which can be a dedicated memory allocated for the particular inference. The working memory can store the facts in the request, as well as additional or inferred facts that are added during the inference. Further, the working memory can store an inference status and query results.

AT 508, the facts are used to perform an inference on the Rete network. Each fact or set of facts may or may not trigger a rule within the Rete network. If a rule is triggered, in some instances, that rule can cause a new fact to be inferred (510). When a new fact is inferred, an intermediate state of the Rete network and the new fact are stored in the working memory (512) and the inference can iteratively continue with the new fact.

At 514, once no further new facts are to be inferred, and each rule in the Rete network has either been triggered or not, an agenda is generated. The agenda can be a list of rules that are triggered, which can include rules granting scope, access, or permissions, and rules indicating actions to be taken.

At 516, the scope is granted according to the agenda. This can include specific permissions or accesses or generally authorization to use one or more computing systems. In some implementations, the scope is defined in an access token that is to be granted to the requester.

At 518, if the agenda includes action rules, the actions associated with those rules are performed. For example, the rules engine can update a user status, change data in a table, or list additional requests or queries that are to be executed on the rules engine, among other things.

FIG. 6 illustrates a schematic diagram of an example computing system 600. The system 600 can be used for the operations described in association with the implementations described herein. For example, the system 600 may be included in computing devices of the one or more online components and/or the one or more offline components. The system 600 includes a processor 610, a memory 620, a storage device 630, and an input/output device 640, which are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 can be a volatile memory unit or a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

1. A computer-implemented method, comprising:
identifying a request to be analyzed by a rules engine;
identifying a plurality of facts associated with the request;
loading the plurality of facts into a working memory;
performing an inference process on a Rete network using the plurality of facts to generate an output of the rules engine; and
generating an agenda that specifies the output of the rules engine.

2. The computer-implemented method of claim 1, wherein identifying the plurality of facts comprises querying an external database and receiving a return.

3. The computer-implemented method of claim 1, wherein performing the inference process on the Rete network using the facts comprises accessing the Rete network in a shared memory, wherein the Rete network is stored as in a read-only format on the shared memory, and wherein the working memory further stores a status of the inference process.

4. The computer-implemented method of claim 1, wherein the Rete network is stored in a shared memory as a concurrency-safe, read-only file.

5. The computer-implemented method of claim 1, comprising:
identifying a plurality of rule definitions;
generating an abstract syntax tree (AST) for each rule definition;
aggregating each AST to generate a concurrency safe Rete network; and
storing the Rete network in a read-only format in a shared memory.

6. The computer-implemented method of claim 1, wherein the agenda comprises a scope, wherein the scope defines a list of permissions associated with the request.

7. The computer-implemented method of claim 1, wherein the agenda comprises an action, wherein the action defines a status to be updated in response to the request.

8. A non-transitory, computer-readable medium storing one or more instructions executable by a computer system to perform one or more operations, comprising:
identifying a request to be analyzed by a rules engine;
identifying a plurality of facts associated with the request;
loading the plurality of facts into a working memory;
performing an inference process on a Rete network using the plurality of facts to generate an output of the rules engine; and
generating an agenda that specifies the output of the rules engine.

9. The computer-readable medium of claim 8, wherein identifying the plurality of facts comprises querying an external database and receiving a return.

10. The computer-readable medium of claim 8, wherein performing the inference process on the Rete network using the facts comprises accessing the Rete network in a shared memory, wherein the Rete network is stored as in a read-only format on the shared memory, and wherein the working memory further stores a status of the inference process.

11. The computer-readable medium of claim 8, wherein the Rete network is stored in a shared memory as a concurrency-safe, read-only file.

12. The computer-readable medium of claim 8, the operations comprising:
identifying a plurality of rule definitions;
generating an abstract syntax tree (AST) for each rule definition;
aggregating each AST to generate a concurrency safe Rete network; and
storing the Rete network in a read-only format in a shared memory.

13. The computer-readable medium of claim 8, wherein the agenda comprises a scope, wherein the scope defines a list of permissions associated with the request.

14. The computer-readable medium of claim 8, wherein the agenda comprises an action, wherein the action defines a status to be updated in response to the request.

15. A computer-implemented system, comprising:
one or more computers; and
one or more computer memory devices interoperably coupled with the one or more computers and having computer-readable storage media storing one or more instructions that, when executed by the one or more computers, perform one or more operations comprising:
identifying a request to be analyzed by a rules engine;
identifying a plurality of facts associated with the request;
loading the plurality of facts into a working memory;
performing an inference process on a Rete network using the plurality of facts to generate an output of the rules engine; and
generating an agenda that specifies the output of the rules engine.

16. The computer-implemented system of claim 15, wherein identifying the plurality of facts comprises querying an external database and receiving a return.

17. The computer-implemented system of claim 15, wherein performing the inference process on the Rete network using the facts comprises accessing the Rete network in a shared memory, wherein the Rete network is stored as in a read-only format on the shared memory, and wherein the working memory further stores a status of the inference process.

18. The computer-implemented system of claim 15, wherein the Rete network is stored in a shared memory as a concurrency-safe, read-only file.

19. The computer-implemented system of claim 15, the operations comprising:
identifying a plurality of rule definitions;
generating an abstract syntax tree (AST) for each rule definition;
aggregating each AST to generate a concurrency safe Rete network; and
storing the Rete network in a read-only format in a shared memory.

20. The computer-implemented system of claim 15, wherein the agenda comprises a scope, wherein the scope defines a list of permissions associated with the request.
